(19) United States
(12) Patent Application Publication
(10) Pub. No.: US 2006/0062334 A1
(43) Pub. Date: Mar. 23, 2006

(54) Method for channel estimation

(75) Inventor: Zing-Wei Kang, Taipei City (TW)

Correspondence Address: LADAS & PARRY, 26 WEST 61ST STREET, NEW YORK, NY, 10023, US

(73) Assignee: BENQ CORPORATION

(21) Appl. No.: 11/216,696

(22) Filed: Aug. 31, 2005

(30) Foreign Application Priority Data
Sep. 3, 2004 (TW) 93126774

(51) Int. Cl. H04L 27/06

(52) U.S. Cl. 375/340

(57) ABSTRACT

A method of channel estimation is for a receiver to receive signals so as to estimate channel impulse response. The signal consists of a first data burst and a second data burst at least where a first training sequence and a second training sequence are interposed between the first data burst and the second data burst respectively. The channel estimation method comprises the following steps. First, estimating the channel impulse response of the first training sequence and the second training sequence respectively where each of the corresponding first channel impulse response and the corresponding second channel impulse response have n impulses so as to gather a first channel impulse response (Aₙ) and a second channel impulse response (Bₙ). Next, estimating channel impulse response (Cₙ) of a designated position of the data burst located between the first training sequence and the second training sequence. The channel impulse response (Cₙ) is estimated by using interpolation by convex function and taking channel impulse response (Aₙ) and (Bₙ) as end values.

### BACKGROUND OF THE INVENTION

(1) Field of the Invention

The invention relates to a method for channel estimation, and more particularly to apply a quadratic function to simulate the characteristic of channel so as to mitigate the Doppler effect for channel estimation.

(2) Description of the Prior Art

FIG. 1 illustrates the basic framework of wireless communication system. The communication system at least includes a transmitter 12 and a receiver 14. Each of the transmitter 12 and receiver 14 has its antenna 16 and 18 for transmitting/receiving signals and then after a number of signal processing steps (such as demodulation, decoding, etc.) so as to get useful data. In the process from transmitter 12 to receiver 14, signals are propagated in channel 20. Ideally, the signal received from the receiver 14 should match the signal transmitted from the transmitter 12.

Actually, the received signals will be affected by refraction or reflection with various objects over the channel 20 or with the relative position changing by transmitter and receiver during the signal transmission. Therefore, the following phenomena might occurre in channel 20 such as multi-path delay, fading, interference, etc. and further conclude signal distortion. Especially for mobile communication system, the relative position of transmitter and receiver are changing frequently that with different speed of moving receiver (or transmitter) results in different level of Doppler spread and causes more seriously distortion problem.

In order to simulate signals in channel transmission, some channel estimation method are adopted to adjust signals being affected in channel so as to compensate the affected signal. In GPRS system, data bursts are transported between a transmitter and a receiver. In FIG. 2, the data burst b1 in received signal may include Data 1, Data 2, and a training sequence ts1 (contains 26 bit digital data) located between Data 1 and Data 2 and data burst b2 has the same arrangement with data burst b1. It should be noted that ts1 and ts2 are predefined data recognized by the receiver and transmitter. Hence, to compare the difference of ts1 in receiver and in transmitter so as to estimate the channel impulse response (CIR) in channel 20 and then with the CIR to compensate Data 1 and Data 2 in data burst b1 and using the same rule to receive Data 3 and Data 4 in data burst b2.

The more detail in prior art method shown in FIG. 3, in step 301, estimating CIR of training sequence ts1 and ts2 separately. For example, there are five taps of CIR A₁` A₂` . . . ` A₅ estimated from ts1 and B₁` B₂` . . . ` B₅ estimated from ts2 also referring to FIG. 2. Then in step 303, determining a predetermined position k located between ts1 and ts2 and estimating CIR of the position k. Next in step 305, by using linear interpolation and substituting the end value Aₙ and Bₙ so as to get CIR(Cₙ) of the predetermined position k As shown in FIG. 2, the first tap of CIR C₁ is determined by taking the end value of A₁ and B₁ using linear interpolation method and using the same rule to get C₂˜C₅.

Alternatively, we can divide the data burst into M parts and estimate corresponding CIRs. In FIG. 2, Data 2 and Data 3 are divided into two parts (M=2) separately, D2_1, D2_2 and D3_1, D3_2. And using the aforementioned method to get CIRs of every part.

Finally, in step 307, we use the estimated CIRs of each data burst to get data. FIG. 4 illustrates the functional block of estimating data in a receiver. We use the channel estimator 40 which is used for estimating CIR of data burst by the aforementioned linear interpolation method and the faded data received by the receiver so as to get more accurate data from the Viterbi equalizer 42.

However, the aforementioned prior art is not suitable in mobile communication system. This is because Doppler effect occurred in moving objects and the aforementioned prior art has no concern about the Doppler effect. Therefore, in order to improve the foregoing disadvantages, the present invention provides a channel estimation method which mentions about Doppler effect.

### SUMMARY OF THE INVENTION

Accordingly, it is one object of the present invention to provide a channel estimation method by using a convex function (e.g. Bessel Function or quadratic function) to simulate the characteristic of channel so as to mitigate the Doppler effect.

Accordingly, it is one more object of the present invention to provide a channel estimation method to consider movement of a transmitter and a receiver so as to compensate the channel estimation error occurred by speed.

The present invention provides a method for channel estimation utilizing in a receiver to receive signals, the signal comprises a first data burst and a second data burst where a first training sequence (ts1) and a second training sequence (ts2) are individually interposed in the first data burst and the second data burst, the channel estimation method comprises the following steps. Firstly, estimating channel impulse responses (CIRs) of the ts1 and the ts2 where each of the ts1 and the ts2 has n impulses so as to get a first CIR (Aₙ) and a second CIR (Bₙ) respectively.

Subsequently, determining an interpolation number M of data burst located between the ts1 and the ts2, the predetermined position are labeled as (d₁)` (d₂) . . . (d_{M}). Next, estimating a plurality of CIRs (Cₙ₁)` (Cₙ₂) . . . (C_{nM}) according to the predetermined position (d₁)` (d₂) . . . (d_{M}), wherein the CIRs, (Cₙ₁)` (Cₙ₂) . . . (C_{nM}) valued by taking the first CIR (Aₙ) and the second CIR (Bₙ) as end value and using the convex function with the predetermined position (d₁)` (d₂) . . . (d_{M}). The convex function can be simplified by a Bessel Function: Cₙ(d)=Aₙ×w_{n,0}(d)+Bₙ×w_{n,1}(d) where d is a predetermined position in data burst located within the ts1 and the ts2, Cₙ(d) is a CIR with the predetermined position, w_{n,0}(d) and w_{n,1}(d) are weight values calculated by the Bessel Function.

It should be noted that the weight value can be calculated be the following equation:

$${w}_{n} ( d ) = \frac{1}{FF ( 2 - FF )} [ \begin{matrix}FF ( 1 - X1 ) - ( X0 - X1 ) \\ FF ( 1 - X0 ) - ( X1 - X0 )\end{matrix} ]$$

, where

$$FF = \frac{{[ 2 π {f}_{D} T ( {d}_{1} - {d}_{0} ) ]}^{2}}{4} , X0 = \frac{{[ 2 π {f}_{D} T ( d - {d}_{0} ) ]}^{2}}{4} , \\ XI = \frac{{[ 2 π {f}_{D} T ( {d}_{1} - d ) ]}^{2}}{4} , {d}_{0} \leq d \leq {d}_{1} ,$$

where f_{D} is Doppler frequency, T denotes time period between received each data bit of the training sequence, and d denotes scalar of the predetermined position (d=t/T). Moreover, the convex function, Fₙ(x), the CIR can be written as:
Cₙ(d)=Aₙ×F_{n,A}(d)+Bₙ×F_{n,B}(d),
where F_{n,A}(d) and F_{n,B}(d) denote estimated CIRs at the predetermined position d individually.

### BRIEF DESCRIPTION OF THE DRAWINGS

The present invention will now be specified with reference to its preferred embodiment illustrated in the drawings, in which

FIG. 1 is a schematic view of basic framework for wireless communication system;

FIG. 2 is a schematic view of composition of data burst transmitted in GPRS system;

FIG. 3 is a flow chart of prior art when receiving data in a receiver;

FIG. 4 is a function block about estimate data in a receiver;

FIG. 5 is a flow chart of receiving data in a receiver in accordance with one embodiment with the present invention;

FIG. 6 is a schematic view of composition of data burst transmitted in GPRS system; and

FIG. 7A˜7C are compensation tables in different speed in accordance with one embodiment with the present invention.

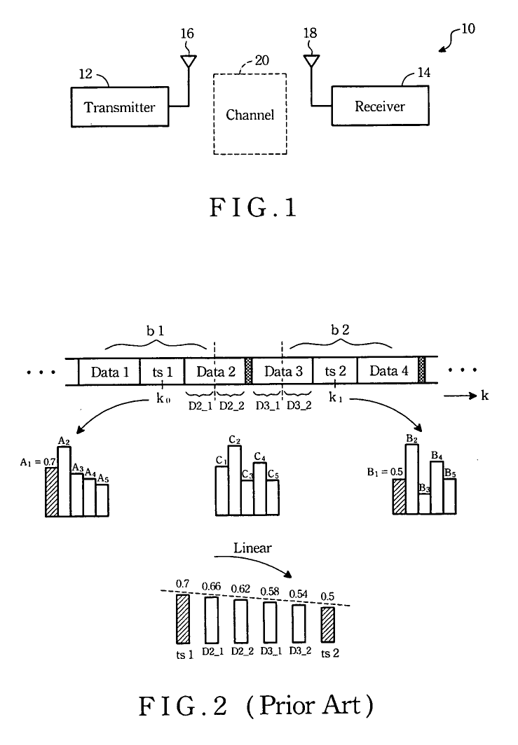

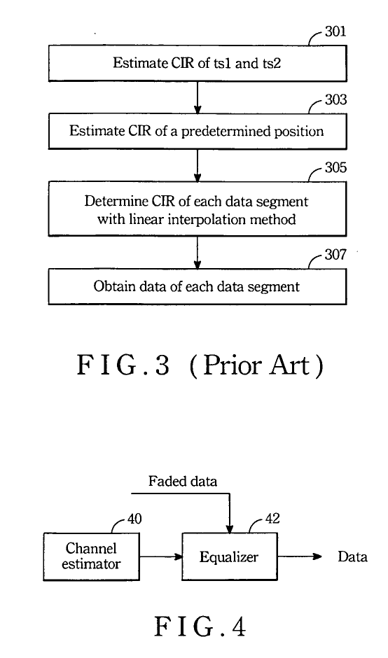

### DESCRIPTION OF THE PREFERRED EMBODIMENT

The invention disclosed herein is a method for channel estimation, and more particularly to apply a convex function to simulate the characteristic of channel so as to mitigate Doppler effect for channel estimation. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

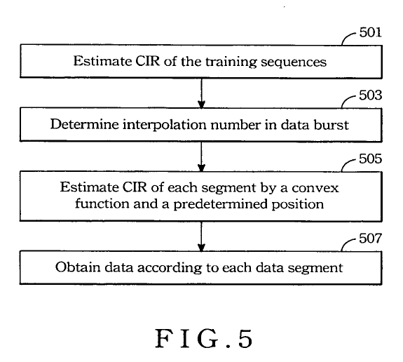

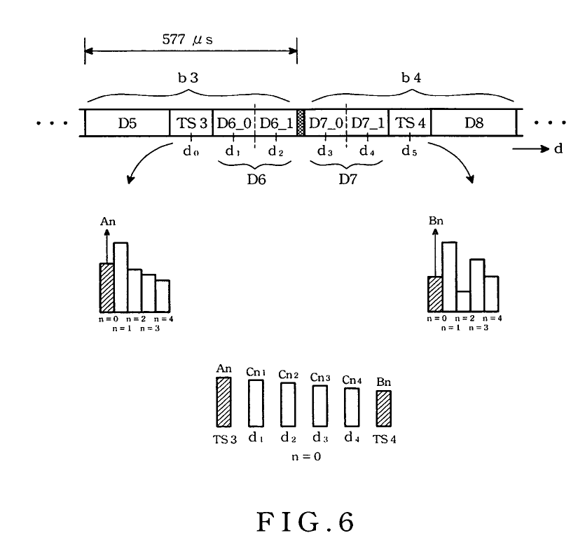

FIG. 5 illustrates a flow chart of receiving data in a receiver in accordance with one embodiment with the present invention. Firstly, estimate channel impulse responses (CIRs) of the training sequences. Also referring to FIG. 6 which illustrates only two adjacent data bursts transmitted in GPRS system where data bursts b3 may contain two data D5, D6 and a training sequence TS3 interposed between D5 and D6. Furthermore, data burst b4 may contain two data D7, D8 and another training sequence TS4 interposed between D7 and D8 where D5, D6, D7, D8 may store audio, video, audio/video or other digital data which may contain 58 bits data.

However, for training sequence of data burst transmitted by transmitter, every training sequence of data burst contains the same digital data (could be contained 26 bits data). During signal transmission, the training sequence in each data burst may not similar any more. For example, we may decide to estimate five taps of CIR in each of TS3 and TS4 in order to find out the characteristic of transmission channel that obtain channel response for data.

Subsequently, in step 503, we determine the interpolation number of data burst. In the present embodiment, we take the data (e.g. D6) and divide it into M segments to receive the corresponding data segments according to time. For example, to receive D6_0 at time d₁, and to receive D6_1 at time d₂ and so as D7_0 and D7_1. In this embodiment, each data is divided into two data segments and received at four points (d1˜d4) of time. Other kind of dividing rule according to bit number of data are well known to the skilled person in the art and definitely any intent to include such a modification shall be within the scope of this invention.

The following step 505 of the present embodiment is to estimate CIR of each divided data segments by a convex function in accordance with a predetermined time position. During step 501, each five taps of CIR in TS3 and TS4 are estimated that the total ten taps of CIR are used for estimating CIR of each data segment (e.g. D6_0, D6_1, D7_0, and D7_1) by the convex function where the convex function is simplified from a Bessel Function. Each CIR, Cₙ(d) of data segment can be valued by the following equation (1):
Cₙ(d)=Aₙ×w_{n,0}(d)+Bₙ×w_{n,1}(d) (1)

where d denotes a predetermined time position of data located between TS3 and TS4, and the estimated CIR at predetermined time position denotes Cₙ(d), w_{n,0}(d) and w_{n,1}(d) denote weight values in Bessel Function. In the present embodiment, weight value wn(d) can be found in equation (2):

$${w}_{n} ( d ) = \frac{1}{FF ( 2 - FF )} [ \begin{matrix}FF ( 1 - X1 ) - ( X0 - X1 ) \\ FF ( 1 - X0 ) - ( X1 - X0 )\end{matrix} ] \qquad ( 2 )$$

where

$$FF = \frac{{[ 2 π {f}_{D} T ( {d}_{1} - {d}_{0} ) ]}^{2}}{4} , X0 = \frac{{[ 2 π {f}_{D} T ( d - {d}_{0} ) ]}^{2}}{4} , \\ XI = \frac{{[ 2 π {f}_{D} T ( {d}_{1} - d ) ]}^{2}}{4} , {d}_{0} \leq d \leq {d}_{1} ,$$

where f_{D} is Doppler frequency, T denotes time period between received of each data bit of training sequence, and d denotes scalar of the predetermined time position (d=t/T), n denotes the received impulse with different delay path, And the following description will illustrate how to get equation (2).

Firstly, In order to get optimum channel response, we have to find minimum square error (MSE) between actual channel responses and estimated channel responses by channel estimation. In other words, we can find optimum weight value to make that square error is minimum. We assume that the estimated CIR is Cₙ(d)=wₙ^{H}(d)Cₙ. According to MSE, which is function of the wₙ, we can use partial derivative,

$$\frac{\partial {ɛ}_{n} ( ⅆ )}{\partial {w}_{n} ( ⅆ )} = 0$$

to find out the optimum weight value for MSE. So, the minimum square error of Optimum Wiener Filter can be written as equation (3):
εₙ(d)=E[|\overline{C}ₙ(d)−Cₙ(d)|²] (3)
where \overline{C}ₙ(d) denotes the ideal CIR, Cₙ(d) denotes the interfered CIR, and Cₙ(d)=wₙ^{H}(d)Cₙ, wₙ^{H}=[w_{n,0}(d) w_{n,1}(d)], then the value of MSE can be proved by the following equations:

$$\begin{matrix}\begin{matrix}{ɛ}_{n} ( d ) = E [ {\vert {\overline{C}}_{n} ( d ) - {C}_{n} ( d ) \vert}^{2} ] \\ = E [ ( {\overline{C}}_{n} ( d ) - {C}_{n} ( d ) ) {( {\overline{C}}_{n} ( d ) - {C}_{n} ( d ) )}^{H} ] \\ = E [ {\overline{C}}_{n} ( d ) {\overline{C}}_{n}^{H} ( d ) - {\overline{C}}_{n} ( d ) {C}_{n}^{H} ( d ) - {C}_{n} ( d ) {\overline{C}}_{n}^{H} ( d ) + {C}_{n} ( d ) {C}_{n}^{H} ( d ) ] \\ = E [ {\overline{C}}_{n} ( d ) {\overline{C}}_{n}^{H} ( d ) ] - E [ {\overline{C}}_{n} ( d ) {C}_{n}^{H} ( d ) ] - E [ {C}_{n} ( d ) {\overline{C}}_{n}^{H} ( d ) ] + E [ {C}_{n} ( d ) {C}_{n}^{H} ( d ) ] \\ = {ρ}_{n} - E [ {\overline{C}}_{n} ( d ) {( {w}_{n}^{H} ( d ) {C}_{n} )}^{H} ] - E [ ( {w}_{n}^{H} ( d ) {C}_{n} ) {\overline{C}}_{n}^{H} ( d ) ] + E [ ( {w}_{n}^{H} ( d ) {C}_{n} ) {( {w}_{n}^{H} ( d ) {C}_{n} )}^{H} ]\end{matrix} & ( 4 ) \\ \begin{matrix}if {ρ}_{n} = E [ {\overline{C}}_{n} ( d ) {\overline{C}}_{n}^{H} ( d ) ] , then \\ {ɛ}_{n} ( d ) = {ρ}_{n} - E [ {\overline{C}}_{n} ( d ) {C}_{n}^{H} ] {w}_{n} ( d ) - {w}_{n}^{H} ( d ) E [ {C}_{n} {\overline{C}}_{n}^{H} ( d ) ] - {w}_{n}^{H} ( d ) E [ {C}_{n} {C}_{n}^{H} ] {w}_{n} ( d ) \\ = {ρ}_{n} - {Y}^{H} ( d ) {w}_{n} ( d ) - {w}_{n}^{H} ( d ) Y ( d ) + {w}_{n}^{H} ( d ) {Xw}_{n} ( d )\end{matrix} & ( 4.1 )\end{matrix}$$

where Y=E[\overline{C}ₙ(d)Cₙ^{H}(d)], X=E[Cₙ^{H}(d)Cₙ^{H}(d)].

By partial derivative calculation with equation (4), the optimum weight value of winener filter is

$$\frac{\partial {ɛ}_{n} ( ⅆ )}{\partial {w}_{n} ( ⅆ )} = 0$$

and get 2Y(d)−2Xwₙ(d)=0. Hence, the optimum wiener filter is
wₙ(d)=X⁻¹Y(d) (5)

However, it is assumed that channel has characteristics of time variant and with multipath which corresponds to the situation of Wide Sense Stationary Uncorrelated Scattering (WSSUS). Then the channel can be written in a form of Bessel Function,

$$\begin{matrix}Y = [ \begin{matrix}E [ {C}_{n} ( {d}_{0} ) {\overline{C}}_{n}^{H} ( d ) ] \\ E [ {C}_{n} ( {d}_{5} ) {\overline{C}}_{n}^{H} ( d ) ]\end{matrix} ] \\ = [ \begin{matrix}E [ {\overline{C}}_{n} ( {d}_{0} ) {\overline{C}}_{n}^{H} ( d ) ] \\ E [ {\overline{C}}_{n} ( {d}_{5} ) {\overline{C}}_{n}^{H} ( d ) ]\end{matrix} ] \\ = [ \begin{matrix}β ( d - {d}_{0} ) \\ β ( {d}_{5} - d )\end{matrix} ] \\ = [ \begin{matrix}{ρ}_{n} \times {J}_{0} ( 2 π {f}_{D} ( d - {d}_{0} ) ) \\ {ρ}_{n} \times {J}_{0} ( 2 π {f}_{D} ( {d}_{5} - d ) )\end{matrix} ] & ( 6 ) \\ X = E [ {C}_{n} {C}_{n}^{H} ] = [ \begin{matrix}{ρ}_{n} + {υ}_{n} & β ( {d}_{5} - {d}_{0} ) \\ β ( {d}_{5} - {d}_{0} ) & {ρ}_{n} + {υ}_{n}\end{matrix} ] \\ {C}_{n} ( d ) = [ \begin{matrix}{w}_{n , 0} ( d ) & {w}_{n , 1} ( d )\end{matrix} ] [ \begin{matrix}{C}_{n} ( {d}_{0} ) \\ {C}_{n} ( {d}_{5} )\end{matrix} ] = {w}_{n}^{H} ( d ) {C}_{n} & ( 7 )\end{matrix}$$

where ρₙ=E[\overline{C}ₙ(d)\overline{C}ₙ^{H}(d)] denotes power of transmitted signal, υₙ=σ²/P denotes power of noise signal, Cₙ(d₀)=Aₙ ` Cₙ(d₅)=Bₙ represent the estimated CIR of TS3 and TS4 separately and will be taken as end values in calculating CIRs of data segments located between TS3 and TS4.

Although the optimum weight value can be calculated from equations (6) and (7), but known from equation (5), in order to obtain the optimum weight value, wₙ(d), that we should calculate the inverse matrix included the Bessel Function which is known as a complex calculation. Hence, we use Taylor expansion to approximately solve the Bessel Function. Furthermore, according to the character of Bessel Function, we ignore the order higher than second to reserve the part of quadratic function (e.g. convex function) with first order and second order so as to get the following equations:

$$\begin{matrix}{w}_{n , 0} ( d ) = \frac{FF ( 1 - X1 ) - ( X0 - X1 )}{FF ( 2 - FF )} {w}_{n , 0} & ( 8 ) \\ {w}_{n , 1} ( d ) = \frac{FF ( 1 - X0 ) - ( X1 - X0 )}{FF ( 2 - FF )} {w}_{n , 1} & ( 9 )\end{matrix}$$

where

$$FF = \frac{{[ 2 π {f}_{D} T ( {d}_{5} - {d}_{0} ) ]}^{2}}{4} , X0 = \frac{{[ 2 π {f}_{D} T ( d - {d}_{0} ) ]}^{2}}{4} , \\ XI = \frac{{[ 2 π {f}_{D} T ( {d}_{5} - d ) ]}^{2}}{4} , {d}_{0} \leq d \leq {d}_{5} , {w}_{n , 0} ( d ) and {w}_{n , 1} ( d )$$

denote the weight values of TS3 and TS4 which time positions are at d₀ and d₅ individually.

When we substitute d=d₀ to the equations (6)` (7)` (8)` (9), and obtain the following equations:
wₙ(d₀)=[w_{n,0} 0] (10)
Y(d₀)=[ρₙβ(d₅−d₀)]^{T} (11)
Y^{H}(d₀)wₙ(d₀)=ρₙw_{n,0} (12)
wₙ^{H}(d₀)Xwₙ(d₀)=(ρₙ+υₙ)×(ρₙw_{n,0})² (13)
Then according to the foregoing equations (10)` (11), (12)` (13) to obtain

$${w}_{n , 0} = \frac{{ρ}_{n}}{{ρ}_{n} + {υ}_{n}} ;$$

similarly,

$${w}_{n , 1} = \frac{{ρ}_{n}}{{ρ}_{n} + {υ}_{n}}$$

can be obtained too, and substitute them to equations (8), (9) to get:

$$\begin{matrix}{w}_{n} ( d ) = [ \begin{matrix}{w}_{n , 0} ( d ) \\ {w}_{n , 1} ( d )\end{matrix} ] \\ = \frac{{ρ}_{n}}{{ρ}_{n} + {υ}_{n}} [ \begin{matrix}\frac{FF ( 1 - X1 ) - ( X0 - X1 )}{FF ( 2 - FF )} \\ \frac{FF ( 1 - X0 ) - ( X1 - X0 )}{FF ( 2 - FF )}\end{matrix} ] \\ = \frac{{ρ}_{n}}{{ρ}_{n} + {υ}_{n}} \frac{1}{FF ( 2 - FF )} [ \begin{matrix}FF ( 1 - X1 ) - ( X0 - X1 ) \\ FF ( 1 - X0 ) - ( X1 - X0 )\end{matrix} ]\end{matrix}$$

If we ignore the effect of noise (to set υₙ=0), the near optimum weight value can be shown as follow:

$${w}_{n} ( d ) = \frac{1}{FF ( 2 - FF )} [ \begin{matrix}FF ( 1 - X1 ) - ( X0 - X1 ) \\ FF ( 1 - X0 ) - ( X1 - X0 )\end{matrix} ] … same with ( 2 )$$

Therefore, the CIR compensated through the near optimum weight value in accordance with the present invention can be obtained by the following equation:

$$\begin{matrix}{C}_{n} ( d ) = [ \begin{matrix}{w}_{n , 0} ( d ) & {w}_{n , 1} ( d )\end{matrix} ] [ \begin{matrix}{C}_{n} ( {d}_{0} ) \\ {C}_{n} ( {d}_{5} )\end{matrix} ] \\ = {C}_{n} ( {d}_{0} ) \times {w}_{n , 0} ( d ) + {C}_{n} ( {d}_{5} ) \times {w}_{n , 1} ( d ) \\ = {A}_{n} \times {w}_{n , 0} ( d ) + {B}_{n} \times {w}_{n , 1} ( d ) … same with ( 1 )\end{matrix}$$

where Cₙ(d₀) is Aₙ, and Cₙ(d₅) is Bₙ, which are estimated from TS3 and TS4.

By way of the foregoing equations, the next step is to estimate CIRs by corresponding weight values. As shown in FIG. 6, first, to estimate first tap of CIR for data segment (D6_0) at d₁ position according to the first CIR (Aₙ, and Bₙ) of TS3 and TS4 at n=0 delay path and the weight values (by equations (8) and (9)), and the interpolation equation (1), the first CIR can be written as:
Cₙ(d₁)=Aₙ(d₀)×w_{n,0}(d₁)+Bₙ×w_{n,1}(d₁) . . . n=0, d=d₁
Similarly, to estimate the first tap of CIR for data segment (D6_1) at d₂ position in accordance with the CIRs of TS3 and TS4 at n=0 and the weight values, the data segment (D6_1) at d₂ can be written as:
Cₙ(d₂)=Aₙ×w_{n,0}(d₂)+Bₙ×w_{n,1}(d₂) . . . n=0, d=d₂

After calculating CIRs of all data segments (D6_0˜D7_1) at n=0 delay path, then follow up the foregoing steps described above to calculate other CIRs of data segments at different delay paths (n=1˜4).

Finally, in step 507, obtain the data of each data segments. Also, referring to FIG. 4, we use channel estimator 40 with the foregoing algorithm in the receiver to estimate all CIRs of each data segment and combine with the faded data received from antenna then through the arithmetic with Virterbe algorithm of equalizer 42 so as to compensate the data distorted with speed.

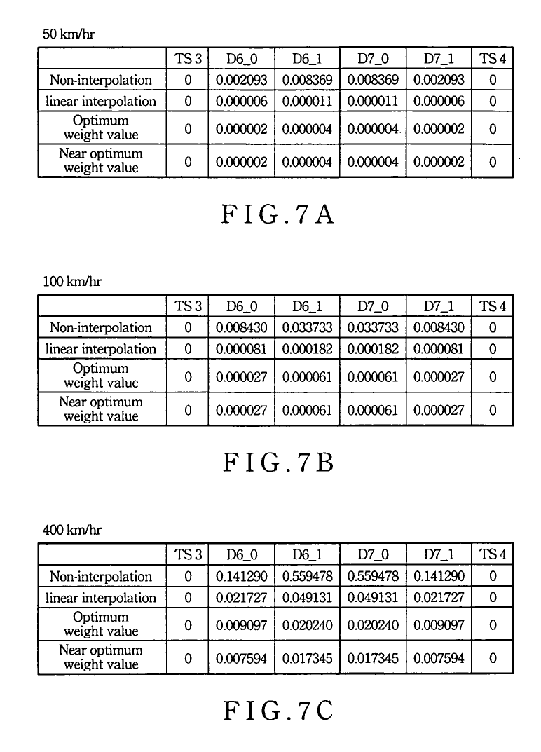

FIG. 7A to FIG. 7C illustrate compensation tables with non-interpolation, linear interpolation, optimum weight value, and near optimum weight value in different speed according to one embodiment with the present invention. It should be noted that transmission duration time in any data burst is about 577 microseconds and Doppler frequency is about 42, 84, 334 Hz at speed of 50, 100, 400 km/hr separately. To get values of every field in each table by normalizing the equation (4.1) written as follow:
εₙ(d)=ρₙ−Y^{H}(d)wₙ(d)−wₙ^{H}(d)Y(d)+wₙ^{H}(d)Xwₙ(d) (4.1)
normalize the equation (4.1) and get:

$${\overline{ɛ}}_{n} ( d ) = \frac{{ɛ}_{n} ( d )}{{ρ}_{n}} = 1 - \frac{{Y}^{H} ( d ) {w}_{n} ( d )}{{ρ}_{n}} - \frac{{w}_{n}^{H} ( d ) Y ( d )}{{ρ}_{n}} + \frac{{w}_{n}^{H} ( d ) {Xw}_{n} ( d )}{{ρ}_{n}}$$

from equation (5): wₙ(d)=X⁻¹Y(d) and get:

$$\begin{matrix}{\overline{ɛ}}_{n} ( d ) = 1 - \frac{{Y}^{H} ( d ) {X}^{- 1} Y ( d )}{{ρ}_{n}} - \frac{{Y}^{H} ( d ) {X}^{- 1} Y ( d )}{{ρ}_{n}} + \frac{{Y}^{H} ( d ) {X}^{- 1} Y ( d )}{{ρ}_{n}} \\ = 1 - \frac{{Y}^{H} ( d ) {X}^{- 1} Y ( d )}{{ρ}_{n}} \\ = 1 - {w}_{n}^{H} ( d ) \frac{Y ( d )}{{ρ}_{n}} \\ = 1 - [ \begin{matrix}{w}_{n , 0} ( d ) & {w}_{n , 1} ( d )\end{matrix} ] [ \begin{matrix}{J}_{0} ( 2 π {f}_{D} ( d - {d}_{0} ) ) \\ {J}_{0} ( 2 π {f}_{D} ( {d}_{5} - d ) )\end{matrix} ] \\ = 1 - {w}_{n , 0} ( d ) \times {J}_{0} ( 2 π {f}_{D} ( d - {d}_{0} ) ) + {w}_{n , 1} ( d ) \times {J}_{0} ( 2 π {f}_{D} ( {d}_{5} - d ) )\end{matrix} \qquad ( 14 )$$

According to the foregoing conditions (such as transmission duration time of data burst, Doppler frequency, etc.) and weight values calculated by different ways (e.g. non-interpolation, linear interpolation, optimum weight values, and near optimum weight values) and substitute to equation (14) so as to get every values of field in tables of FIG. 7A to FIG. 7C. As shown in values of tables, the weight values using near optimum weight has a relatively small error compare to the weight values using linear interpolation of prior art technology.

It should be noted that in the foregoing embodiment, we use TS3 and TS4 of data burst b3 and b4 to get data D6 and D7. Moreover, data D5 of data burst b3 and D8 of data burst b4 should be utilized by the front side training sequence of data burst b3 (maybe b2, but not shown) and the back side training sequence of data burst of b4 (maybe b5, but not shown) and using the method disclosed in the present invention so as to get all data of each data burst.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which d0 not depart from the spirit and scope of the present invention.

I claim:

1. A method of channel estimation in a receiver to receive signals, the signal comprises a first data burst and a second data burst where a first training sequence (ts1) and a second training sequence (ts2) are individually interposed in the first data burst and the second data burst, the channel estimation method comprises the steps of:
estimating channel impulse responses (CIRs) of the ts1 and the ts2 where each of the ts1 and the ts2 has n impulses so as to get a first CIR (Aₙ) and a second CIR (Bₙ) respectively; and
estimating CIR of a predetermined position of data burst located between the ts1 and the ts2, said estimated CIR includes n impulses valued (Cₙ) separately, said (Cₙ) valued by taking the first CIR (Aₙ) and the second CIR (Bₙ) as end value and using a convex function with the predetermined position.

2. The channel estimation method according to claim 1, further comprising the steps of:
determining an interpolation number M of data burst located between the ts1 and the ts2, the predetermined position are labeled as (d₁)` (d₂) . . . (d_{M});
estimating a plurality of CIRs (Cₙ₁)` (Cₙ₂) . . . (C_{nM}) according to the predetermined position (d₁)` (d₂) . . . (d_{M}) wherein the CIRs, (Cₙ₁)` (Cₙ₂) . . . (C_{nM}) valued by taking the first CIR (Aₙ) and the second CIR (Bₙ) as end value and using the convex function with the predetermined position (d₁)` (d₂) . . . (d_{M}).

3. The channel estimation method according to claim 1, wherein the convex function is a Bessel Function, Cₙ(d)=Aₙ×w_{n,0}(d)+Bₙ×w_{n,1}(d) where d is a predetermined position in data burst located within the ts1 and the ts2, Cₙ(d) is a CIR with the predetermined position, w_{n,0}(d) and w_{n,1}(d) are weight values calculated by the Bessel Function.

4. The channel estimation method according to claim 3, wherein position of the ts1 is labeled as d₀, and position of the ts2 is labeled as d₁, the weight value,
$${w}_{n} ( d ) = \frac{1}{FF ( 2 - FF )} [ \begin{matrix}FF ( 1 - X1 ) - ( X0 - X1 ) \\ FF ( 1 - X0 ) - ( X1 - X0 )\end{matrix} ]$$
where
$$FF = \frac{{[ 2 π {f}_{D} T ( {d}_{1} - {d}_{0} ) ]}^{2}}{4} , X0 = \frac{{[ 2 π {f}_{D} T ( d - {d}_{0} ) ]}^{2}}{4} , \\ X1 = \frac{{[ 2 π {f}_{D} T ( {d}_{1} - d ) ]}^{2}}{4} , {d}_{0} \leq d \leq {d}_{1} ,$$
where f_{D} is Doppler frequency, T denotes time period between received each data bit of the training sequence, and d denotes scalar of the predetermined position (d=t/T).

5. The channel estimation method according to claim 1, wherein the convex function, Fₙ(x), the CIR can be written as:
Cₙ(d)=Aₙ×F_{n,A}(d)+Bₙ×F_{n,B}(d),
where F_{n,A}(d) and F_{n,B}(d)denote estimated CIRs at the predetermined position d individually.

6. The channel estimation method according to claim 1, wherein the data burst contains 58 bits data.

7. The channel estimation method according to claim 1, wherein the training sequence within the data burst contains 26 bits data.

8. The channel estimation method according to claim 1, wherein n ranges from 0 to 4.

9. The channel estimation method according to claim 1, wherein the channel estimation method is applied in GPRS system.

10. The channel estimation method according to claim 1, wherein data of the data burst belongs to audio data.

11. The channel estimation method according to claim 1, wherein data of the data burst belongs to video data.

12. The channel estimation method according to claim 1, wherein data of the data burst belongs to audio and video data.
